(19) United States
(12) Patent Application Publication
(10) Pub. No.: US 2004/0157639 A1
(43) Pub. Date: Aug. 12, 2004

(54) Systems and methods of mobile restore

(76) Inventors: Roy D. Morris, Fountain Valley, CA (US); Richard G. Han, Yorba Linda, CA (US); Brian Nam Hoang, Santa Ana, CA (US); Mark J. Borgeson, Lake Forest, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/721,475

(22) Filed: Nov. 25, 2003

Related U.S. Application Data
(60) Provisional application No. 60/429,983, filed on Nov. 27, 2002.

(51) Int. Cl. H04M 3/00

(52) U.S. Cl. 455/550.1; 455/418

(57) ABSTRACT

The systems and methods of the present invention relate to the restoration of data to a mobile device after failure. The systems and methods backup information to a non-volatile memory and detect corrupted information such that the corrupted information may be replaced with valid information.

### RELATED APPLICATION

This application claims the benefit of U.S. Provisional Patent Application Serial No. 60/429,983, entitled “Mobile Restore” and filed Nov. 27, 2002, the disclosure of which is hereby incorporated by reference in its entirety.

### BACKGROUND OF THE INVENTION

1. Field of the Invention

This invention relates to the field of mobile applications. In particular, it relates to systems and methods of restoring data to a mobile device after failure.

2. Description of the Related Art

As the availability of wireless services increases, the demand for wireless applications increases as well. One common problem with conventional applications, however, is that they are unable to handle large numbers of users. An additional problem with conventional applications is that they do not adapt to situations where the wireless users are not constantly connected to a central server. A further problem with conventional applications is that they cannot recover when the mobile device experiences a system failure.

### SUMMARY OF THE INVENTION

The systems and methods of the present invention relate to the restoration of data to a mobile device after failure. The systems and methods backup information to a non-volatile memory and detect corrupted information such that the corrupted information may be replaced with valid information.

One benefit of some embodiments is that data on a mobile device is stored to memory on the mobile device so that in the event of a failure, data is not lost. An additional benefit of some embodiments is that the backup to non-volatile memory may be performed in the background such that it is transparent to the user. Another benefit of some embodiments is that the backup is performed automatically, without requiring any initiation by a user. A further benefit of some embodiments is that the detection of failures is automatic and may be performed in the background as a transparent process. Another benefit of some embodiments is that the mobile device may be restored without requiring any connection to the server 130.

One embodiment of the present invention is a mobile device apparatus. The mobile device apparatus comprises a short term memory; an application program configured to store data in the short term memory; a long term memory; a store program configured to store data in the short term memory in the long term memory; a restore program configured to detect a discrepancy between data stored in the short term memory and data stored in the long term memory; and if a discrepancy is detected, to copy data related to the discrepancy from the long term memory in the short term memory.

An additional embodiment of the present invention is a method of mobile restore. The method of mobile restore comprises periodically storing data saved in short term memory to long term memory; detecting discrepancies between the data saved in short term memory and the data saved in long term memory; and if discrepancies are detected, replacing the data saved in short term memory with the data saved in long term memory.

A further embodiment of the present invention is a method of detecting failure of a mobile device. The method comprises receiving a first set of data from volatile memory; receiving a second set of data from non-volatile memory; and determining whether the first set of data matches the second set of data.

An additional embodiment of the present invention is a mobile device apparatus. The mobile device apparatus comprises volatile memory; an application program configured to store data in the volatile memory; non-volatile memory; a first module configured to access data in the volatile memory and store it in the non-volatile memory; and a second module configured to determine a discrepancy exists between data stored in the volatile memory and data stored in the non-volatile memory, and at least partly in response to determining discrepancy exists, to access data related to the discrepancy from the non-volatile memory and to store the accessed data in the volatile memory.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

FIG. 1 illustrates a high-level block diagram of one embodiment of a mobile application system.

FIG. 2 illustrates a high-level block diagram of a mobile device.

FIG. 3 illustrates one embodiment of a flow chart for a restoration process.

### DETAILED DESCRIPTION OF PREFERRED EMBODIMENTS

Systems and methods that represent various embodiments and example applications of the invention will now be described with reference to the drawings. Variations to the systems and methods that represent other embodiments will also be described.

For purposes of illustration, some embodiments will be described in the context of a field service system. The inventors contemplate that the present invention is not limited by the type of environment in which the systems and methods are used and that the systems and methods may be used in various environments. Some of the descriptions, however, relate to an embodiment of the invention wherein the environment is that of field service systems.

It is also recognized that the systems and methods may be implemented as a single module and/or implemented in conjunction with a variety of other modules and the like. Moreover, the specific implementations described herein are set forth in order to illustrate, and not to limit, the invention. The scope of the invention is defined by the appended claims.

Various features will now be described with reference to the drawings summarized above. The drawings and the associated descriptions are provided to illustrate embodiments of the invention and not to limit the scope of the invention. Throughout the drawings, reference numbers may be re-used to indicate correspondence between referenced elements. In addition, the first digit of each reference number generally indicates the figure in which the element first appears.

### I. Sample Operation

The systems and methods of the present invention provide a mobile application system that enables the restoration of data to mobile devices after detection of a failure. For purposes of illustration, a sample scenario will now be discussed where the mobile application system is implemented in a field service system.

In a field service system, technician systems are wirelessly networked to service centers, customers, and parts warehouses, allowing information to be shared automatically among the parties. Requests may be taken from the customer by the service center, and these requests are used to prepare work orders, which are then assigned to an available technician. The technician receives the work order and an alert that the work order has been assigned to him. At this point, the technician may perform the work order and send information back to the service center. This information may be provided automatically without any explicit activity by the technician other than following the interface prompts of the technician system. The information is received by the service center where it may be used to compute invoices or to keep the customer informed of the status of the technician's work.

The communication between the service center and the technician system provides great assistance to the technicians enabling them to efficiently and accurately complete their jobs. Such assistance may be interrupted, however, if the technician system experiences some type of failure. In such circumstances, the technician may be unable to reconnect to the server to obtain the information needed to complete a work order. In other cases, even if the technician is able to communicate with the server, the server may not have an up-to-date copy of information from the technician system.

As noted above, the technician system communicate with a server to receive and send work order information, messages, customer information, work order history, parts inventory information, time sheets, and other pertinent information. Next, as technicians process work order requests, the technician system stores information about the work order requests, the technician's settings, the mobile device's communication protocol for communicating with the server, and other information in persistent memory on the technician system. When the technician then logs onto his mobile device, the current settings and data on the device are compared to the information stored in persistent memory on the technician system. If there are any discrepancies (i.e., the current settings and/or data are incorrect), the information stored in persistent memory on the technician system is used to update the current settings and/or data in temporary memory allowing the technician to complete his or her work order without knowing that the technician system had experienced a failure.

Additional information about various embodiments of a field service system is discussed in U.S. application Ser. No. 09/638,451, entitled “Method and Systems for Managing a Field Service System,” filed on Aug. 14, 2000, which is hereby incorporated by reference in its entirety.

While the example above involves the use of a field service system, it is recognized that this example is used only to illustrate features of one embodiment of a mobile application system. Further, the mobile application system may be used in other environments and may be used with other types of and/or applications, including, without limitation, cell phone updates, software updates and upgrades, data processing updates and changes, and so forth.

### II. Mobile Application System

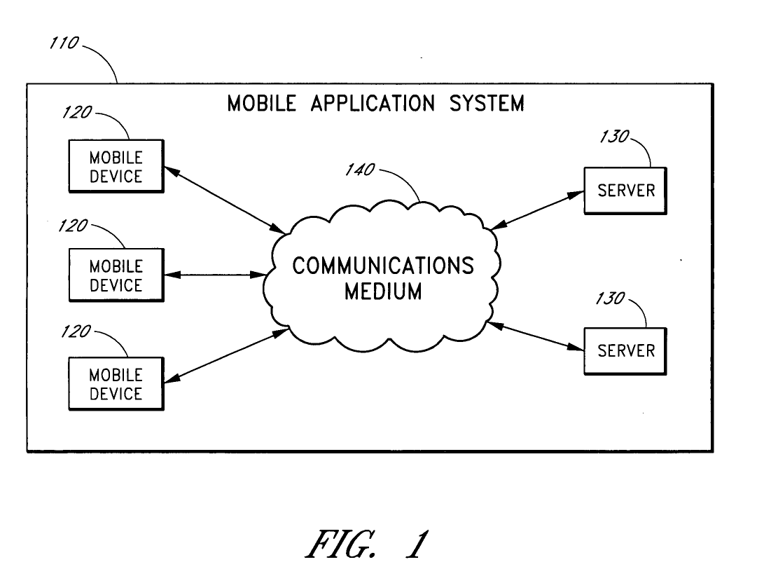

FIG. 1 illustrates one embodiment of a mobile application system 110 wherein mobile devices 120 communicate with a server 130 via a communications medium 140.

The term “mobile” may include devices, components, and/or modules that are portable and that may be disconnected from the server 130, such that the server 130 is not accessible via the local bus. Thus, a mobile device 120 may include a device that is physically located in the same room and connected via a device such as a switch, a local area network, or a wireless network modem. In other situations, a mobile device 120 may also be located in a separate geographic area, such as, for example, in a different location, country, and so forth.

In one embodiment the mobile device 120 is physically disconnected from the server 130 for at least some amount of time, such as, for example, a device that is connected to the server 130 but then unplugged for a period of time. In other embodiments, the mobile device 120 is never physically connected to the server 130, such as, for example, a cell phone that communicates with the server 130 using wireless communications.

A. Mobile Devices

1. Components

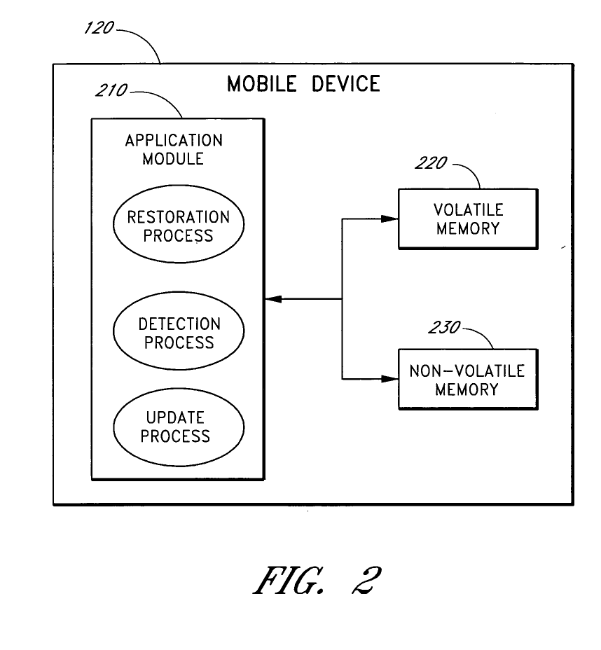

FIG. 2 illustrates one embodiment of the mobile device 120 shown in FIG. 1. The exemplary mobile device 120 includes an application module 210, a volatile memory 220, and a non-volatile memory 230.

a. Application Module

The exemplary application module 210 includes a restoration process, a detection process, and an update process, which are discussed in detail below in the section entitled “Mobile Application System Processes.”

b. Volatile Memory

The exemplary volatile memory 220 is a storage device that does not retain its contents when power is turned off. For example, volatile memory 220 may be Random Access Memory (“RAM”), and so forth.

c. Non-Volatile Memory

The exemplary non-volatile memory 230 is a storage device that retains its contents when power is turned off. For example, the non-volatile memory 230 may be a compact flash memory, a memory stick, a smart media card, a micro-drive, a USB flash drive, a secure digital memory, a multimedia card, a hard drive, an optical drive, battery backed RAM, as well as other non-volatile memory 230. In some embodiments, the non-volatile memory 230 may be easily or readily removable from the mobile device 120 whereas in other embodiments, the non-volatile memory 230 may be more permanently attached to the mobile device 120.

2. System Information

In one embodiment, the mobile device 120 enables the user to communicate with the server 130 via the communications medium 140. In particular, the mobile device 120 is advantageously a portable computer. Those of skill in the art will recognize that a “portable computer” may include, without limitation, an enhanced cellular phone or paging device, a personal digital assistant, a handheld computer, a laptop computer, a computer embedded in another device such as a clipboard, a wearable computer, a tablet computer, or any other such device as in known in the art. The present invention is not, however, limited to embodiments in which a portable computer is used as the mobile device 120.

As used herein, “computer” or “computer system” is used to refer broadly to any data processing system or terminal. The exemplary computers described herein may be small business computers as well as servers that are in use at a particular site. However, those skilled in the art will recognize that other types of computer systems are possible and may be used in different circumstances. These computer systems include, without limitation, multi-user computer systems, enhanced telephones and pagers, personal digital assistants, interactive audio and video kiosks, interactive television systems, handheld computers, personal digital assistants, and such other devices as are known in the art. In addition, the computer may use one or more microprocessors, such as, for example, a Pentium processor, a Pentium II processor, a Pentium Pro processor, a Pentium IV processor, other Intel processors, an xx86 processor, an 8051 processor, a MIPS processor, a Power PC processor, a SPARC processor, a Macintosh processor, an Alpha processor, and so forth. Furthermore, the microprocessor may runs one or more operating systems, such as, for example, Microsoft® Windows® CE, Microsoft® Windows® XP, Microsoft® Windows® 3.X, Microsoft® Windows 98, Microsoft® Windows(® 2000, Microsoft® Windowsg NT, Microsoft® Windows® CE, Microsoft® Windows & ME, Apple® MacOS®, Disk Operating System (DOS), UNIX or other UNIX variants, IRIX, Solaris, SunOS, FreeBSD, Linux®, IBM(® OS/2X) operating systems, Palm OS, BeOS, EPOC, and so forth.

In one embodiment, the mobile device 120 is equipped with conventional wireless network connectivity, such as, for example, Personal Area Networks (PANs), including but not limited to Bluetooth, Local Area Networks (LANs), including but not limited to 802.11a, 802.11b, 802.11g, Wireless Wide Area Networks (WWANs), including but not limited to CDPD, CDMA IS-95, CDMA 1xRTT, CDMA 1xEVDO, Datatac 4000, Mobitex, GPRS, iDEN, EDGE, and Satellite-based protocols. Further, the wireless device 120 may be configured to support a variety of network protocols such as, for example NFS v2/v3 over UDP/TCP, Microsoft® CIFS, HTTP 1.0, HTTP 1.1, DAFS, FTP, and so forth.

3. Sample Wireless Devices

One example of a mobile device 120 is a technician system used by a field technician to perform work at remote job sites. In one embodiment, the technician system is a small portable computer with an integrated input device, such as an integrated keyboard, pointing device, or touch screen. For example, the technician system may comprise an HPC (handheld personal computer) running Microsoft Windows CE as its operating system, wherein the HPC is configured to communicate with a service center to send and receive work order data. The technician system may use a wireless Internet access protocol to communicate with the service center such that communication between the technician system and the service center is automatic and transparent to the technician using the system.

Another example of a wireless device 120 is a cell phone system used by a stockbroker to perform stock trades. In one embodiment, the cell phone system is an enhanced cellular phone with a touch screen that is integrated with the cell phone input buttons. The enhanced cellular phone may run Palm OS, Microsoft Pocket PC Software, or the Microsoft Smartphone operating system, and be configured to communicate with a call center to send and receive trading data. The enhanced cell phone may communicate with the call center using a wireless alphanumeric pager protocol. The communication between the cell phone system and the call center may be automatic or prompted by the user.

The provided examples illustrate environments in which the mobile application system 110 may be used. It is recognized, however, that other environments may be used and that other embodiments and/or combinations of mobile devices 120, servers 130, and/or communication media 140 may be used.

B. Server

In one embodiment, the server 130 runs on a computer that enables communication between the servers 130 and the mobile devices 120. The computer may be a general purpose computer using one or more microprocessors, such as, those discussed above. In addition, the processor unit runs one or more of the operating systems, also discussed above. In one embodiment, the server 130 is also equipped with conventional network connectivity, and may be configured to support a variety of network protocols.

1. Sample Server

One example of a server 130 is the service center of a field service system. The service center may be used as a clearing house and data storage/forwarding area for the communications that will take place between the technician system and the service center. In addition, the service center may be used to coordinate and control information that is distributed to various other systems, such as a customer computer, a home office computer, and an inventory computer.

An additional example of a server 130 is a call center of a cell phone system. The call center may be configured to send and receive information to and from enhanced cellular phones. The information may include stock trade data that the call center may then process to conduct stock trades.

The provided examples illustrate environments in which the mobile application system 110 may be used. It is recognized, however, that other environments may be used and that other embodiments and/or combinations of mobile devices 120, servers 130, and/or communications media 140 may be used.

C. Communications Medium

Focusing now on the communications medium 140, the exemplary communications medium 140 may include a wireless network in one mode of operation, such as CDMA networks, microwave networks, or wireless DSL networks. However, other communications media 140 may be used for various connections between the systems. These communications media 140 can include, without limitation, land line telephone connections, analog or digital cellular telephone connections, radio frequency communications, pager networks, television cable networks, and other forms of communication as are known in the art. In addition, the computer systems may optionally be capable of switching from one communications medium 140 to another.

1. Sample Communications Medium

In a field service system, it may be is desirable that there are multiple means available for the technician system to exchange data with the service center. In some embodiments, dial-up land-line telephone connections between the technician system and the service center may be used. These connections can be made whenever the technician is at a location where it is convenient and appropriate for the technician system to be physically connected to a land-line phone.

Although these connections are reliable and nearly universally available, a connection using a land line phone requires that the technician system is not moving far from the landline port during this connection. As a result, this sort of connection is not desirable for all circumstances in which the technician system is operated. For these circumstances, it is advantageous for there to be a wireless connection of some kind between the mobile technician system and the service center.

Such wireless connections can include systems such as cellular modems, both analog and digital, wireless alpha-numeric pager based communications, and wireless Internet access. In one mode of operation, wireless Internet access is made available for the technician system using a wireless Internet transport protocols known in the art, such as Ardis, Mobitex or WinSock based communications networks. In a particularly advantageous mode of operation, multiple wireless transport protocols are supported by the technician system, as well as allowing for manually initiated dial-up connections. In this way, the technician system is able to be in communication with the service center as much as possible in as seamless a way as possible.

In addition to providing for wireless data exchange between the technician system and the service center, it is beneficial for the communications media 140 in use between the service center and the technician system to be able to automatically reconnect after an unanticipated disconnection, and to automatically recover messages which may have been in transit during the disconnection.

These recovery and reconnect functions may be configured to occur without need for intervention by the technician. As soon as a communications link is available, communications are made between the remote system and service center as necessary. If the link is broken, communications are queued and then restarted upon reestablishment of a communications link.

One of ordinary skill in the art will recognize that a wide range of communications media 140 may be employed in the present invention. For example, the communications medium 140 may include, without limitation, interactive television networks, telephone networks, land-line networks, wireless alpha-numeric pager based communications, wireless Internet, other wireless networks, wireline networks, cellular networks, wireless data transmission systems, two-way cable systems, customized computer networks, interactive kiosk networks, local area networks, wide area networks, satellite networks, intranet networks, broadband networks, baseband networks, and the like, as well as any combination of the above.

### III. Mobile Application System Processes

The exemplary mobile application system 110 includes a restoration process, a detection process, and an update process.

A. Restoration Process

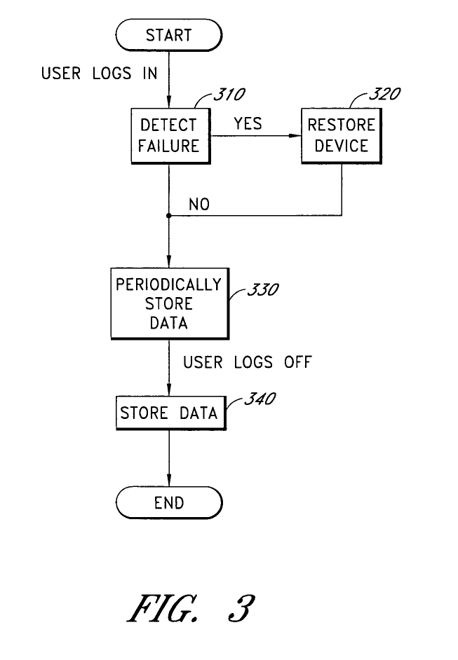

FIG. 3 illustrates one embodiment of a flow chart for restoring information on the mobile device 120 (“restoration process”).

In one embodiment, the restoration process automatically begins when a user logs onto the mobile device 120. In other embodiments, however, the restoration process may be initiated by the user, by the server 130, or by another event. Furthermore, in some embodiments, the restoration process may be used regardless of whether the mobile device 120 is able to communicate with and/or is in current communication with the server 130.

Beginning at a start state, the restoration process proceeds to the next state and detects whether there has been some type of data failure (state 310). A detailed description of one embodiment of a detection process is described below. If there has been some type of data failure, the restoration process updates the mobile device 120 to the last saved state (state 320). A detailed description of one embodiment of an update process is described below. Next, the restoration process proceeds to the next state and periodically stores data saved in the mobile device's volatile memory 220 to the mobile device's non-volatile memory 230 (state 330).

It is recognized that various sets of data may be stored on the non-volatile memory 230 including, without limitation, program settings (e.g., number of days to keep certain records, workflow options, etc.), binary files, data files, queued messages (including status messages and data), database records (e.g., industry templates, material catalogs, vendor catalogs, etc.), infrastructure data, transactional data, system registry data, communications software, communications software settings, and so forth. Furthermore, in some embodiments, all of the data does not have to be stored each time a store is performed. For example, some sets of data may not typically be modified while the mobile device 120 is in use, such as, for example, the IP address of the server 130. Thus, in some embodiments, the IP address of the server 130 may be stored during initialization of the mobile device 120 and not stored on a periodic basis, but only when the system detects that the IP address setting has been changed. In other embodiments, the IP address may be stored on a periodic basis. In other embodiments, all of the data is stored.

In some embodiments, data is stored specific to each user that logs onto the system. For example, if Joe and Gene both log onto the system, then data for both Joe and Gene may be stored on the system. Thus, the system is able to support multiple users sharing the same mobile device 120 such that if the mobile device 120 crashes, data for the multiple users may be restored even if each user's settings and files may be different. In other embodiments, the data may be stored such that it is not user-specific. If Joe logs on first and then Gene logs on, then only Gene's data is currently stored on the system.

In addition, in some embodiments, the data may be stored based on a preset time (e.g., every X fraction of a second, where X is a predetermined number, every second, every five seconds, every five minutes, at the top of every hour, etc.), based on the occurrence of certain events (e.g., every key stroke, every one hundredth key stroke, upon the close of an application, upon use of the “Enter” key, when the “OK” button is clicked, and so forth), based on specific initiation by the user or the server 130, based on each time data is stored to volatile memory 220, as well as any combination of the above to non-volatile memory 230.

In one embodiment, the restoration process performs a final store of the data when the user logs off the mobile device 120 (state 340) and proceeds to an end state. The final store may save all of the data or a subset of the data.

In some embodiments, when a new mobile device 120 is first used, various programs and data may be stored on the mobile device 120. For example, the initial installation may include storing application programs, binary files, data related to the application programs, communications software, communications software settings, system registry data, database records, and so forth. This information is stored to both the volatile and non-volatile memory 230. The installation may include data related to one or more specific users and/or default user settings.

In other situations, for example, if the installation is conducted to replace a failed mobile device 120, the installation may store the last saved set of information from the user's failed mobile device 120. In such cases, the stored information may also include information such as queued messages that were to be sent to the server 130.

The restoration process may be used to recover from a variety of system failure, such as, for example, when the battery or other power supply of the mobile device 120 is drained or disconnected; when the mobile device 120 is destroyed or not functioning, when a user performs a hard reset on the mobile device 120, or other functions that remove the current files from the volatile storage 240 of the mobile device 120, when the operation system of the mobile device 120 freezes requiring the user to reset the mobile device 120, and so forth.

In some situations, the data may be restored by enabling the non-volatile memory 230 to be accessed via a working mobile device 120. For example, a memory card may be removed from the non-working mobile device 120 and inserted into a working mobile device 120. As another example, the hard drive of a non-working mobile device 120 may be connected to a working mobile device 120.

FIG. 3 illustrates one embodiment of the restoration process. It is recognized that other embodiments of a restoration process may be used.

B. Detection Process

The exemplary application module 210 also includes a process for detecting failures on the mobile device 120 (“detection process”). In a typical environment, a user will log onto the mobile device 120, such as, for example, by entering a user login and a password. In other embodiments, the user may only need to “power up” the mobile device 120 to be logged on. Once the user has logged on, the mobile device 120 readies the device for use by starting any applicable applications. During a normal start up, the operation system of the device may load information into volatile memory 220, where such information may be later used by the mobile device 120. The information loaded into the RAM at startup may include, but is not limited to, device drivers, service processes, and applications configured to start at operating system startup. After the information has been loaded into volatile memory 220, the detection process may be initiated.

The detection process determines whether the data in the volatile memory 220 of the mobile device 120 matches data stored in the non-volatile memory 230 of the mobile device 120. In one embodiment, the determination may be made by comparing the data using standard checksum techniques, that is a check sum based on the data stored in volatile memory 220 is compared to a check sum based on the data stored in non-volatile memory 230. Other methods of data comparison, error correction, and/or error detection may be used.

In one embodiment, the detection process first compares the files stored in memory and then compares the system registry entries stored in memory. In other embodiments, other data may be checked and/or other sets of data may be checked. In addition, the entire contents of volatile memory 220 may be compared to the entire contents of non-volatile memory 230.

Furthermore, while various embodiments of a detection process are discussed above, it is recognized that other embodiments of a detection process may be used.

C. Update Process

The exemplary application module 210 also includes a process for updating the volatile memory 220 of the mobile device 120 (“update process”). Once a discrepancy has been detected between data in the volatile memory 220 and data in the non-volatile memory 230, the update process determines which data should be updated and then copies the appropriate data from non-volatile memory 230 to volatile memory 220. In one embodiment, the detection process may inform the update process as to what data is corrupt. For example, the detection process may inform the update process that the data in the queues is corrupt. Then, the update process may copy the queue data from non-volatile memory 230 to volatile memory 220. In other embodiments, the update process may determine what data is corrupt. In such cases, the update process may utilize error correction and/or detection techniques to determine what data is corrupt and then to copy the appropriate data from non-volatile memory 230 to volatile memory 220. In other embodiments, the update process may copy all of the restore-related data from non-volatile memory 230 to volatile memory 220.

In some embodiments, the update process may copy only a subset of the corrupt data. For example, the update process may determine that certain data is not critical and thus, not update the data. In other embodiments, all of the corrupt data, regardless of content may be updated. Furthermore, while various embodiments of an update process are discussed above, it is recognized that other embodiments of an update process may be used.

### IV. Conclusion

While certain embodiments of the invention have been described, these embodiments have been presented by way of example only, and are not intended to limit the scope of the present invention. Accordingly, the breadth and scope of the present invention should be defined in accordance with the following claims and their equivalents.

What is claimed is:

1. A mobile device apparatus comprising:
a short term memory;
an application program configured to store data in the short term memory;
a long term memory;
a store program configured to store data in the short term memory in the long term memory; and
a restore program configured to detect a discrepancy between data stored in the short term memory and data stored in the long term memory, and if a discrepancy is detected, to copy data related to the discrepancy from the long term memory in the short term memory.

2. The mobile device apparatus of claim 1, wherein the store program is further configured to run automatically.

3. The mobile device apparatus of claim 1, wherein the restore program is further configured to run automatically.

4. The mobile device apparatus of claim 1, wherein the short term memory is at least one of a compact flash memory, a memory stick, a smart media card, a micro-drive, a USB flash drive, a secure digital memory, a multimedia card, and a hard drive.

5. The mobile device apparatus of claim 1, wherein the restore program is further configured to detect a discrepancy using check sum techniques.

6. The mobile device apparatus of claim 1, wherein the data stored includes at least one of application program data, program settings, binary files, queued messages, infrastructure data, communications software, transactional data, communications software settings, system registry data, and database records.

7. A method of mobile restore comprising:
periodically storing data saved in short term memory to long term memory;
detecting discrepancies between the data saved in short term memory and the data saved in long term memory; and
if discrepancies are detected, replacing the data saved in short term memory with the data saved in long term memory.

8. The method of claim 7, wherein the data periodically saved in short term memory is automatic.

9. The method of claim 8, wherein the data periodically saved in long term memory is automatic.

10. The method of claim 7, wherein the discrepancies are automatically detected.

11. The method of claim 7, wherein the replacing the data saved in short term memory is automatic.

12. The method of claim 11, wherein the replacing the data saved in long term memory is automatic.

13. The method of claim 7, wherein the discrepancies are detected using check sum techniques.

14. The method of claim 7, wherein the data periodically saved in short term memory includes at least one of application program data, program settings, binary files, queued messages, infrastructure data, communications software, transactional data, communications software settings, system registry data, and database records.

15. A method of detecting failure of a mobile device, the method comprising:
receiving a first set of data from volatile memory;
receiving a second set of data from non-volatile memory; and
determining whether the first set of data matches the second set of data.

16. The method of claim 15 further comprising if the first set of data does not match the second set of data, replacing the first set of data with the second set of data in volatile memory.

17. The method of claim 15, wherein determining whether the first set of data matches the second set of data comprises determining whether the first set of data is an exact duplicate of the second set of data.

18. The method of claim 15 further comprising if the first set of data does not match the second set of data identifying a subset of the first set of data that does not match the second set of data.

19. The method of claim 15 further, wherein check sum techniques are used to determine whether the first set of data matches the second set of data.

20. A mobile device system comprising:
means for periodically storing data saved in short term memory to long term memory;
means for detecting discrepancies between the data saved in short term memory and the data saved in long term memory; and
means for replacing the data saved in short term memory with the data saved in long term memory if discrepancies are detected.

21. A system having a storage device containing instructions that, when executed, cause the system to perform the method of:
periodically storing data saved in short term memory to long term memory;
detecting discrepancies between the data saved in short term memory and the data saved in long term memory; and
if discrepancies are detected, replacing the data saved in short term memory with the data saved in long term memory.

22. A mobile device apparatus comprising:
volatile memory;
an application program configured to store data in the volatile memory;
non-volatile memory;
a first module configured to access data in the volatile memory and store it in the non-volatile memory; and
a second module configured to determine a discrepancy exists between data stored in the volatile memory and data stored in the non-volatile memory, and at least partly in response to determining discrepancy exists, to access data related to the discrepancy from the non-volatile memory and to store the accessed data in the volatile memory.

23. The mobile device apparatus of claim 22, wherein the first module is configured to automatically access data in the volatile memory and automatically store it in the non-volatile memory.

24. The mobile device apparatus of claim 22, wherein the second module is configured to automatically determine a discrepancy exists.

25. The mobile device apparatus of claim 22, wherein the second module is configured to automatically access data related to the discrepancy from the non-volatile memory and to store the accessed data in the volatile memory.

26. The mobile device apparatus of claim 22, wherein the second module is configured to use check sum techniques to determine whether a discrepancy exists.

27. The mobile device apparatus of claim 22, where the data stored in volatile memory includes at least one of application program data, program settings, binary files, queued messages, infrastructure data, communications software, transactional data, communications software settings, system registry data, and database records.
